(19) United States
(12) Patent Application Publication
(10) Pub. No.: US 2015/0029588 A1
(43) Pub. Date: Jan. 29, 2015

(54) Control of Light Wavefronts

(71) Applicants: Marco Fiorentino, Mountain View, CA (US); David A. Fattal, Mountain View, CA (US); Raymond G. Beausoleil, Redmond, WA (US)

(72) Inventors: Marco Fiorentino, Mountain View, CA (US); David A. Fattal, Mountain View, CA (US); Raymond G. Beausoleil, Redmond, WA (US)

(21) Appl. No.: 14/357,776

(22) PCT Filed: Dec. 9, 2011
(86) PCT No.: PCT/US2011/064125

§ 371 Date: May 13, 2014

(51) Int. Cl. G02B 5/18; G02B 1/10

(52) U.S. Cl. CPC G02B 5/1809; G02B 5/1861; G02B 5/1847; G02B 1/10
USPC 359/572; 359/569; 427/162; 156/314

(57) ABSTRACT

Techniques to control light wavefronts are described herein. A plurality of sub-wavelength grating (SWG) layers includes a SWG layer. The SWG layer is arranged to control a light wavefront.

### BACKGROUND

Wavefront control devices are devices that influence the travel direction of an incident wavefront or of at least some of its spectral components. Examples of wavefront control devices include prisms, light beam splitters, wavelength filters, or combinations thereof Such devices may be used, for example, to direct a light beam in a particular direction, to split a light beam in its spectral components, or to block some spectral components in a light beam.

Wavefront control devices may include multiple elements combined to control an incident wavefront in a particular manner. For example, multiple triangular prism elements may be combined to perform spectral dispersion without causing deviation of an incident wavefront at a design wavelength. Further, a wavefront control device may combine elements of different types. For example, a beam steering system may use a combination of mirrors, prisms and lenses to change the direction, shape, and spectral composition of an incident wavefront.

There is a trend towards mass-production of compact optical devices including wavefront control devices. However, following this trend is challenging since elements such as prisms, beam splitters, or the like may be expensive to manufacture when particular specifications have to be met. Further, elements of these devices (e.g., prisms) may be relatively voluminous so that integration in a single device may be difficult.

### BRIEF DESCRIPTION OF THE DRAWINGS

In order that the present disclosure may be well understood, various examples will now be described with reference to the following drawings.

FIG. 1A is a perspective view of a wavefront control device according to an example.

FIG. 1B is a cross-sectional view along line A-A of the wavefront control device shown in FIG. 1A.

FIG. 2 is a cross-sectional view of another wavefront control device operated according to an example.

FIG. 3 is a cross-sectional view of yet another wavefront control device operated according to another example.

FIG. 4 shows a top plane view of a sub-wavelength (SWG) layer configured with a grating pattern according to an example.

FIG. 5 shows a cross-sectional view of a SWG according to an example.

FIGS. 6A and 6B show plots of transmittance and phase shift as a function of duty cycle of a SWG layer according to an example herein, shown in FIG. 6C.

FIG. 7 shows a cross sectional view of a SWG layer in operation illustrating how a transmitted wavefront may be changed according to an example.

FIG. 8A shows a top plan view of a SWG layer configured according to an example; FIG. 8B shows a cross-sectional view of the SWG layer of FIG. 8A in operation.

FIG. 9 shows a cross-sectional view of the SWG layer of FIG. 8A in operation for splitting a multiple component wavefront.

FIG. 10 shows a cross-sectional view of another example of a SWG layer in operation for filtering a spectral component of a multiple component wavefront.

FIG. 11A shows a top plan view of a SWG layer configured according to another example; FIG. 11B shows a cross-sectional view of the SWG layer of FIG. 11A in operation.

FIG. 12 shows a diagram depicting a process flow for manufacturing a wavefront control device according to examples.

FIGS. 13A to 13I show cross-section views of structures for manufacturing a wavefront control device according to an example of the process flow in FIG. 12.

FIGS. 14A to 14K show cross-section views of structures for manufacturing a wavefront control device according to an example of the process flow in FIG. 12.

FIGS. 15A and 15B show cross-section views of structures for manufacturing a wavefront control device according to an example of the process flow in FIG. 12.

In the drawings, the dimensions of layers and regions are exaggerated for clarity of illustration.

### DETAILED DESCRIPTION

In the following description, numerous details are set forth to provide an understanding of the examples disclosed herein. However, it will be understood by those skilled in the art that the examples may be practiced without these details. Further, in the following detailed description, reference is made to the accompanying figures, in which various examples are shown by way of illustration. In this regard, directional terminology, such as “top,” “bottom,” “front,” “back,” “left,” “right,” “vertical,” etc., is used with reference to the orientation of the figures being described. Because disclosed components can be positioned in a number of different orientations, the directional terminology is used for purposes of illustration and is in no way limiting. Like numerals are used for like and corresponding parts of the various figures. While a limited number of examples are illustrated, it will be understood that there are numerous modifications and variations therefrom.

As set forth above, wavefront control devices may be expensive to manufacture. Moreover, it may be difficult to integrate its elements in a single device.

Wavefront control devices to control light wavefront are described herein including a plurality of sub-wavelength grating (SWG) layers. In examples herein the SWG layers are stacked. Further, the SWG stack includes a SWG layer arranged to control a light wavefront.

A SWG layer refers to a layer that includes a diffraction grating with a pitch that is sufficiently small to suppress all but the 0^{th} order diffraction. In contrast thereto, conventional wavelength diffraction gratings are characterized by a pitch that is sufficiently high to induce higher order diffraction of incident light. In other words, conventional wavelength diffraction gratings split and diffract light into several beams travelling in different directions. How the SWG layer refracts an incident beam may be determined at manufacturing by properly selecting the dimensions of the diffractive structure of the SWG.

As detailed below in Section CONFIGURING SUB-WAVELENGTH GRATINGS, a SWG layer may be arranged to control a wavefront incident thereon. More specifically, gratings with a non-periodic, sub-wavelength pattern may be configured to impart an arbitrary phase front on the impinging beam. Thereby, an arbitrary diffractive element may be realized. Wavefront control may be realized in devices described herein by configuring one or more SWG layers to perform particular wavefront control functions. For example, SWG layers may be configured to deflect an incident wavefront so as to change its travel direction, to split an incident wavefront into spectral components, or to filter specific spectral components of an incident wavefront. Furthermore, such SWG layers for wavefront control may be combined with SWG layers configured to collimate, focus, or expand the controlled wavefront so as to provide further functionalities in a wavefront control device.

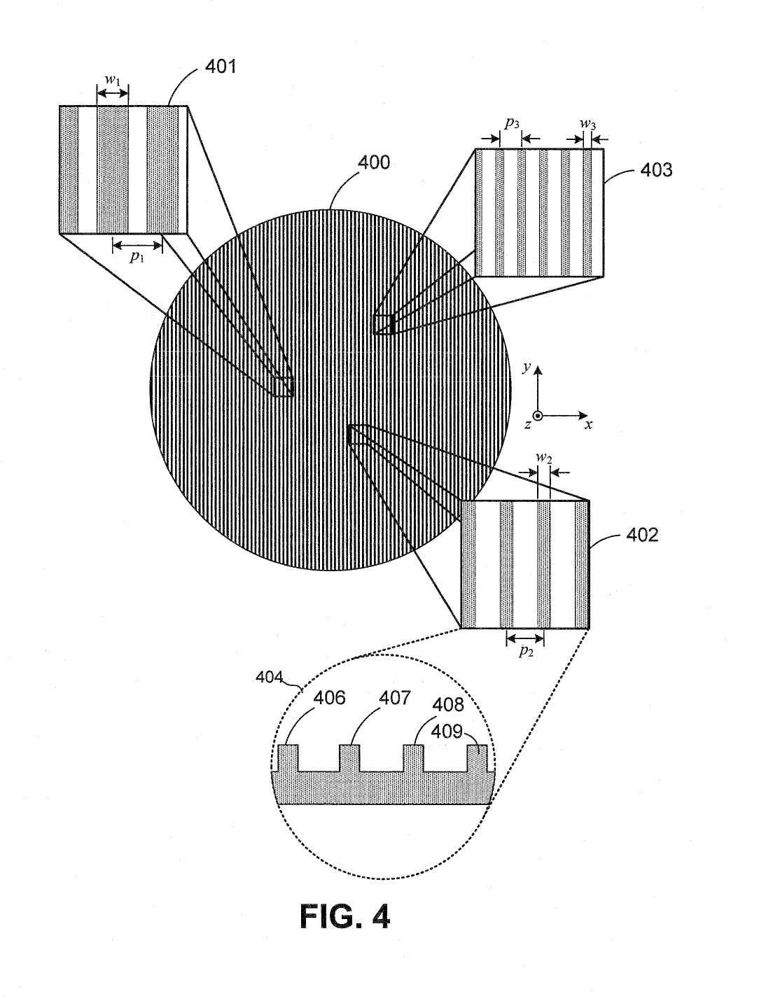

A stack of SWG layers as described herein facilitates building multiple functions in a wavefront control device. For example, a SWG layer may be arranged to collimate a plurality of parallel incident beams and another layer may be arranged to control an incident wavefront by separating the parallel incident beams, as illustrated with respect to FIG. 3. Further, examples herein facilitate constructing a compact wavefront control device since SWG layers are planar structures that can be conveniently integrated into a single device. Moreover, such compact wavefront control device may be mass-produced since, as illustrated in Section FABRICATING WAVEFRONT CONTROL DEVICES, SWG layers may be easily fabricated using micro-fabrication procedures and high volume production methods such as standard CMOS processes or roll-to-roll imprinting.

In the following description, the term “light” refers to electromagnetic radiation with wavelength(s) in the visible and non-visible portions of the electromagnetic spectrum, including infrared and ultra-violet portions of the electromagnetic spectrum. The term “wavefront” refers to the locus (i.e., a line or, in a wave propagating in three dimensions, a surface) of points in a light beam having the same phase. The term “stack” refers to an ordered heap of SWG layers. Spacers may be interposed between the SGW layers of a stack. It will be understood that when a layer or film is referred to or shown as being ‘between’ two layers or films, it can be the only layer or film between the two layers or films, or one or more intervening layers or films may also be present.

WAVEFRONT CONTROL DEVICES: the wavefront control devices described herein are provided to illustrate some examples of a vast variety of possible arrangements of SWG layers that can be used to implement control of a wavefront. Wavefront control devices are contemplated with any number, spacing, and arrangement of SWG layers to implement optical functionalities facilitating a specific control of a wavefront incident on the device. At least one of the SWG layers is arranged to control a light wavefront. Specifically, a SWG layer may be arranged to influence the travel direction of a wavefront or of at least some of its spectral components (e.g., direct a beam in a particular direction, split a beam in its spectral components, or filter a spectral component in the wavefront).

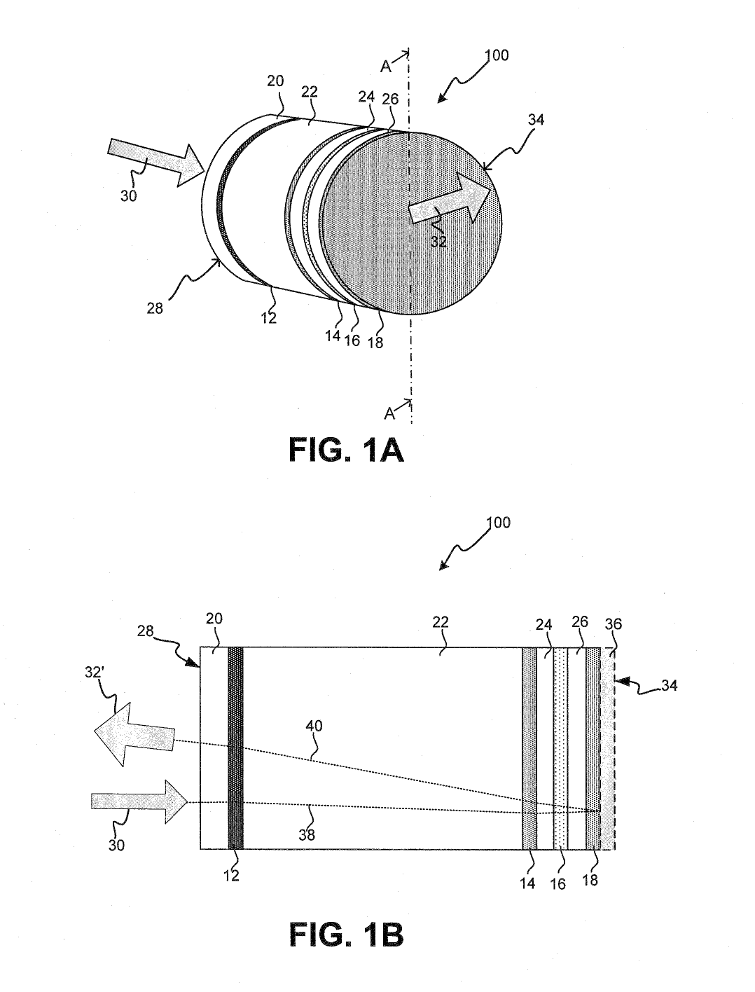

FIG. 1A shows a perspective view of a wavefront control device 100 according to an example. FIG. 1B shows a cross-sectional view of device 100 along a line A-A. In the illustrated example, device 100 includes stacked sub-wavelength grating (SWG) layers 12, 14, 16, 18. Spacers 20, 22, 24, 26 are interposed between the SWG layers. The spacers define relative positions between adjacent SWG layers. The spacers may be comprised of a substantially transparent material, (e.g., a silicon oxide) as further detailed below so that a wavefront can be transmitted between SWG layers. The spacers may include one or more substrates on which SWG layers are formed. Further, the spacers may include deposition layers onto which SWG layers are formed.

At least one of SWG layers 12, 14, 16, 18 is arranged to control a light wavefront incident therein. Other SWG layers may also be arranged to control a light wavefront incident therein or to implement other optical functionalities such as focusing a wavefront, expanding a wavefront, collimating a wavefront, or polarizing components of a wavefront.

The SWG layers can be composed of any suitable material, such as a semiconductor including silicon (“Si”), gallium arsenide (“GaAs”), indium phosphide (“InP”), silicon carbide (“SiC”), or a combination thereof In examples herein, a spacer is comprised of a solid material for separating adjacent SWG layers. The spacers may be composed of a suitable polymer or another dielectric material such as a transparent silicon oxide. The spacers may have a refractive index lower than for an adjacent SWG layers.

Generally, the thickness and composition of the spacers are chosen to implement, in conjunction with the SWG layers, the specific functionality of the wavefront control device. More specifically, a wavefront to be controlled by a wavefront control device as described herein traverses one or more spacers. Further, the spacer(s) defines the relative position between SWG layers. Therefore, the constitution of the spacer(s) (i.e., dimensions and optical properties) influences how a device controls a wavelength incident thereon. Consequently, the spacer(s) may be arranged considering the functionality to be implemented by the particular wavefront control device.

A spacer acts as a high precision separator between the optical components of a wavefront control device. Furthermore, as further illustrated below, a spacer may include a substrate on which a SWG layer is formed. Thereby, design and fabrication of a wavefront control device is simplified without compromising high precision positioning of its components.

The above components of device 100 are arranged to control a wavefront 30 incident on a first end surface 28 of device 100. As shown in FIG. 1A, a second end 34 of device 100 may be configured to transmit a wavefront 32 controlled according to a specific wavefront control function.

Device 100 may be configured as a reflecting wavefront control device that reflects an incident wavefront according to a specific wavefront control function. More specifically, as illustrated in FIG. 1B, device 100 may optionally include a reflecting layer 36 at second end 34 so that incident wavefront 30 is reflected thereon after (i) undergoing a first control stage while traversing a transmission optical path 38 and (ii) undergoing a second control stage while traversing a reflection optical path 40. Reflecting layer 36 may include a suitable material for reflection such as a dielectric material; a semiconductor; or a metal, such as gold (“Au”) or silver (“Ag”). Furthermore, reflective layer 36 may include a SWG layer configured to reflect an incident wavefront. Device 100 is configured to emit at first end surface a wavefront 32′ controlled according to a specific wavefront control function implemented by SWG layers 12-18. In the illustrated device, by way of example, SWG layers 12, 14 are arranged to implement wavefront control by changing the travel direction of an incident wavefront.

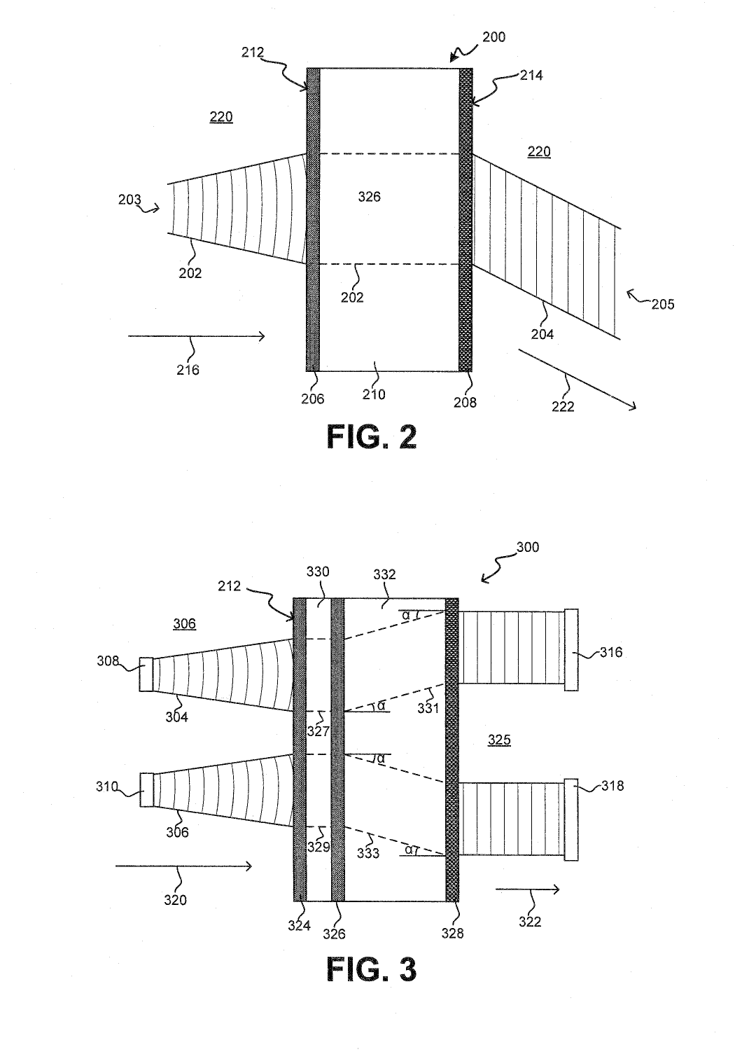

According to some examples, a wavefront control device may implement directional control of a plurality of beams. For example, a wavefront control device may be arranged to separate a plurality of incident beams from each other. FIG. 2 is a cross-sectional view of a wavefront control device 200 operated according to an example. Device 200 is designed to control an input beam 202 propagating in free space 220 along a direction 216 in a specific manner so that it emits a controlled output beam 204 into free space 220 along a deflected direction 222; input beam 202 includes a wavefront 203, and output beam 204 includes a wavefront 205. The wavefronts are represented by the thin locus lines. Control device 200 includes a first SWG layer 206 and a second SWG layer 208. A spacer 210 is in-between first SWG layer 206 and second SWG layer 208 so as to define the relative position between each other. A first end surface 212 (an input surface) is configured to receive input beam 202; a second end surface 214 (an output surface) is configured to emit an output beam 204.

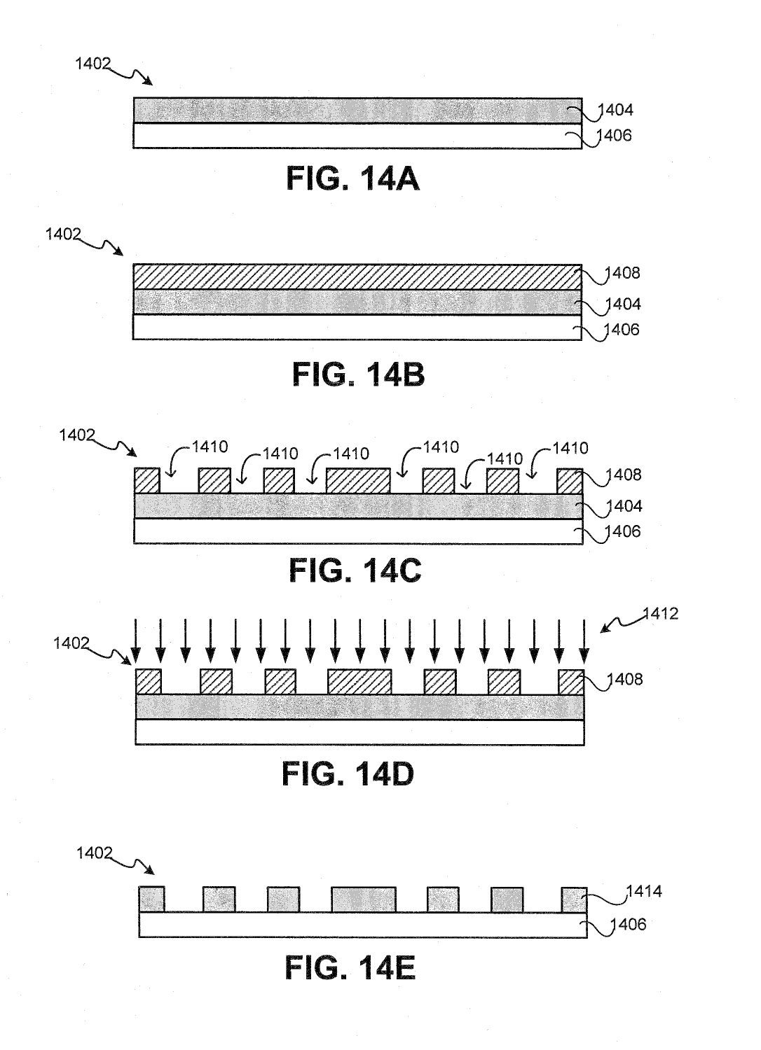

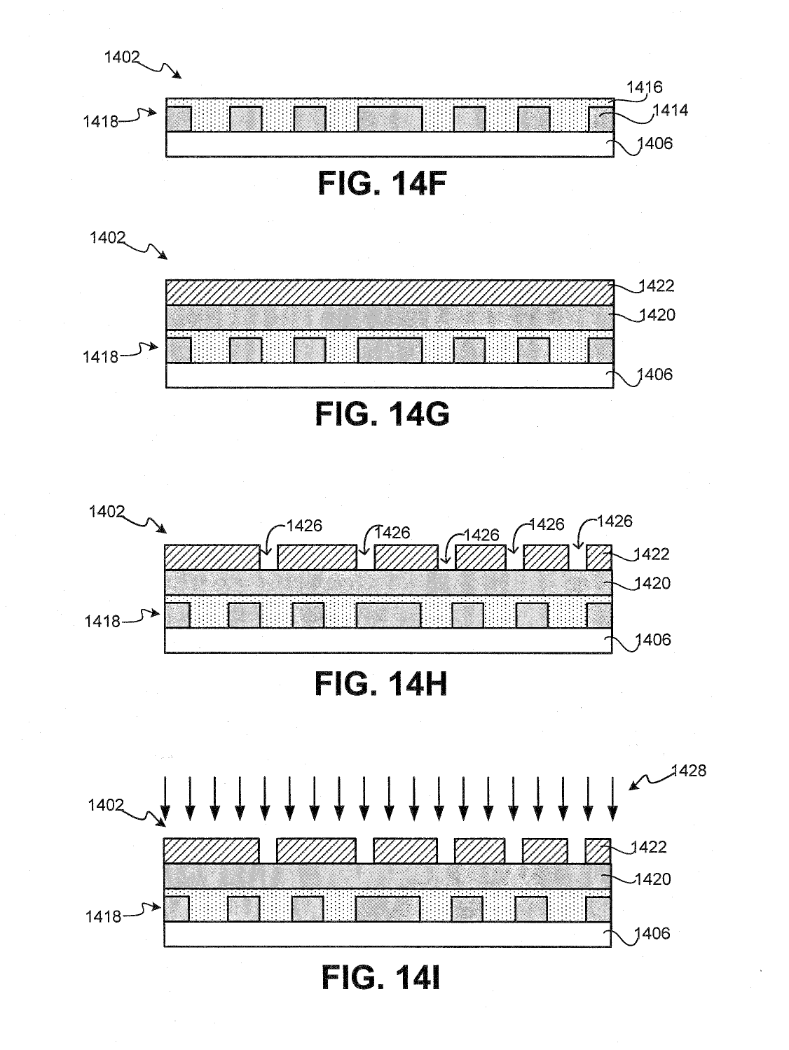

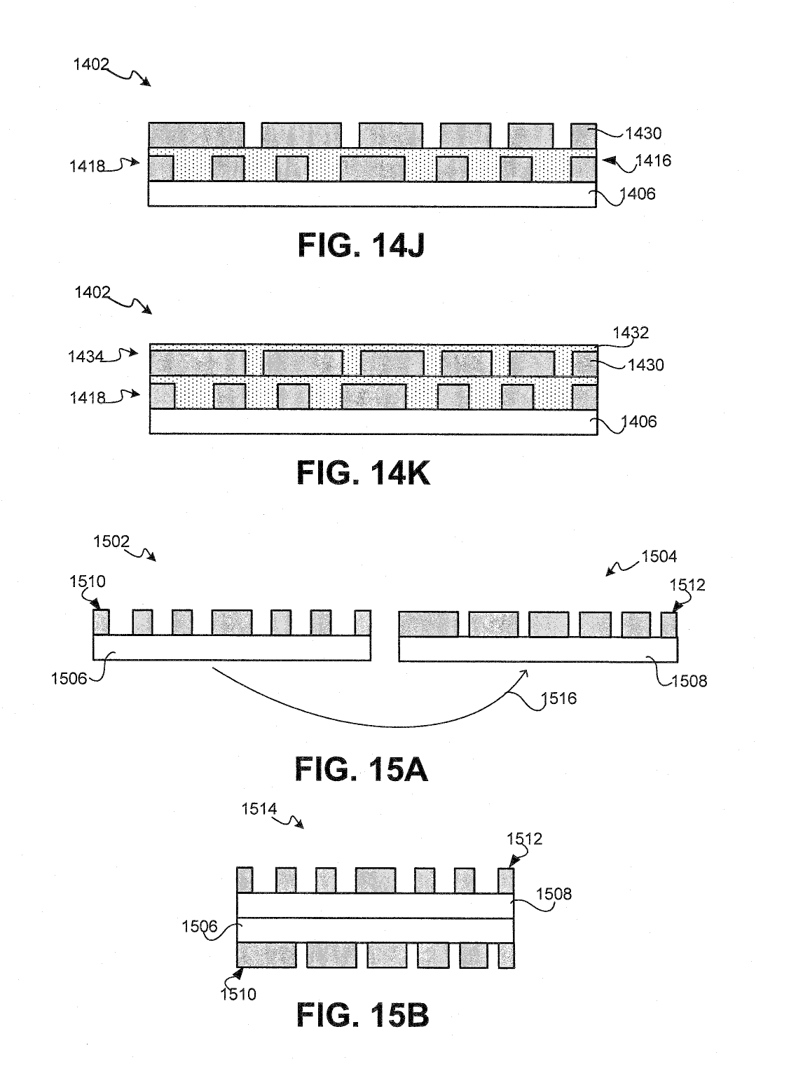

Spacer 210 may include, or be constituted as, a substrate on which first SWG layer 206, second SWG layer 208, or both layers are formed as illustrated with respect to FIG. 13I or 14K. In alternative examples, each SWG layer and its respective substrate form an integrated structure; both integrated structure are bonded to each other such that spacer 210 includes both substrates, as illustrated with respect to FIG. 15B.

Device 200 illustrates an example that implements control of a diverging beam for generating an output beam that is collimated and deflected with respect to incident direction 216 of the input beam. As illustrated in FIG. 2, input beam 202, incident on device 200 at first end surface 212, has a diverging wavefront 203. First SWG layer 206 acts upon diverging wavefront 203 so as to converge them into a collimated beam 218. In the illustrated example, spacer 210 is comprised of a transparent material such that collimated beam 218 traverses spacer 210 in the same direction 216 as beam 202. Collimated beam 218 impinges on second SWG layer 208. Second SWG layer 208 deflects collimated beam 218 in a deflected travel direction 222. A controlled output beam 204 is transmitted from second end surface 214 into free space 220.

FIG. 3 is a cross-sectional view of another wavefront control device 300 operated according to an example. Device 300 is designed to control input beams 302, 304 propagating in first medium 306 along an input direction 320. Input beams 302, 304 are emitted from source channels 308, 310 and controlled by device 300 into output beams 312, 314 shaped and deflected for being coupled into output channels 316, 318 along output direction 322 in medium 325. Thereby, device 300 effects beam separation of input beams 302, 304. A wavefront control device effecting beam separation may be useful for a variety of applications. For example, device 300 may form part of a multiple terminal (MT) optical connector. A MT connector may be designed to, for example, connect a bundle of optical fibers (or a multicore optical cable) to a photonic integrated circuit (PIC), splice the output of optical fibers, connect a PIC to a PIC, interconnect bundles of optical fibers, or interconnect optical fiber bundles or multicore optical cables.

Device 300 includes a collimating SWG layer 324, a deflecting layer 326, and a further deflecting layer 328. A spacer 330 is interposed between SWG layer 324 and deflecting layer 326; a further spacer 332 is interposed between deflecting SWG layers 326 and 328. In the illustrated example, spacers 330, 332 are comprised of a transparent material. Device 300 may be arranged at free space (in that case, media 306, 325 may be air). Alternatively, device 300 may include further layers that physically connect the device to channels 308, 310, 316, 318. Further, device 300 and the channels may be integrated as a single device.

As illustrated by FIG. 3, the process of controlling input beams 302, 304 by device 300 may involve the following events. Input beams 302, 304 are emitted by source channels 308, 310 with diverging wavefronts. Input beams 302, 304 are incident on device 300 at first end surface 212. Collimating SWG layer 324 acts upon the diverging wavefronts so as to so as to converge them into collimated beams 327, 329. Collimated beams 327, 329 are transmitted between collimating SWG layer 324 and deflecting SWG layer 326 through spacer 330. Deflecting SWG layer 326 acts upon collimated beams 327, 329 so as to deflect them an angle α into deflected beams 331, 333. Deflected beams 331, 333 are transmitted between collimating deflecting SWG layer 326 and deflecting SWG layer 328 through spacer 332. Deflecting SWG layer 328 acts upon deflected beams 331, 333 so as to deflect them an angle α into output beams 312, 314 directed towards output channels 316, 318.

It will be understood that the separation distance d between input beams and output beams depends, among other features, on (a) the deflection angle α, and (b) on the thickness of spacer 332. Further, in the illustrated example, deflecting SWG layers 326, 328 are illustrated as inducing the same deflection angle, however, each of them may be arranged to induce deflection at different angles.

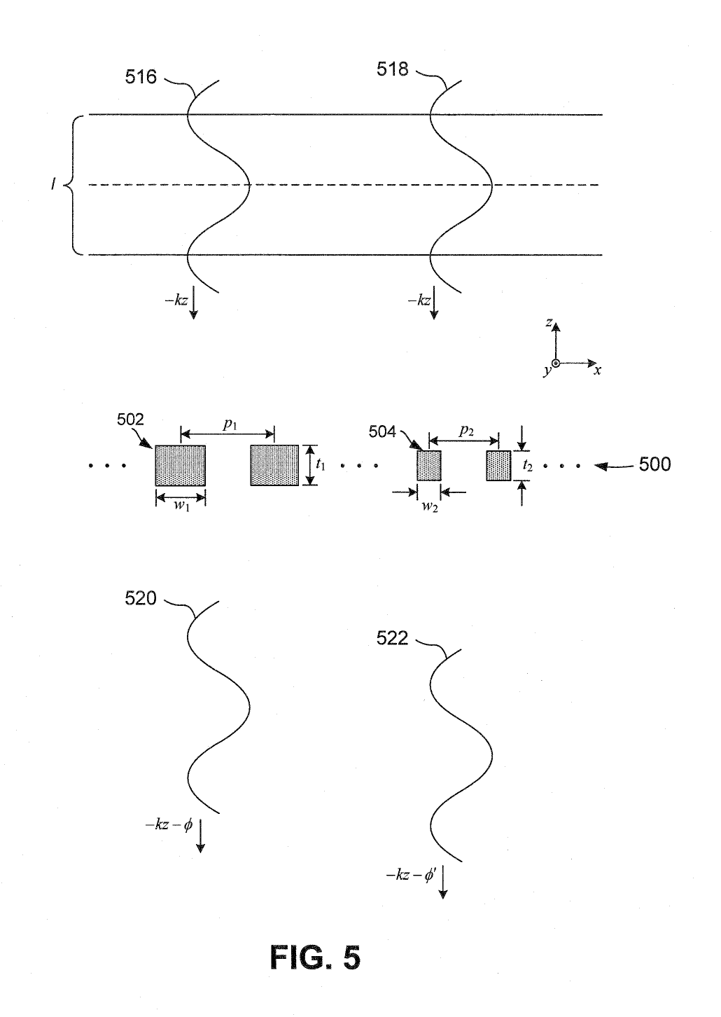

CONFIGURING SUB-WAVELENGTH GRATINGS: FIG. 4 shows a top plane view of a SWG layer 400 configured with a grating pattern according to an example. In this example, SWG layer 400 includes a number of one-dimensional grating sub-patterns. Three grating sub-patterns 401-403 are depicted enlarged. Each grating sub-pattern includes a number of regularly arranged diffractive structures. In the depicted example, the diffractive structure is illustrated as spaced wire-like portions of SWG layer material (hereinafter referred to as “lines”). The lines extend in the y-direction and are spaced in the x-direction. An enlarged end-on view 404 of grating sub-pattern 402 is also depicted. As illustrated by end-on view 404, SWG layer 400 may be a single layer with lines, such as lines 406-409, separated by grooves formed in the layer.

A sub-pattern of a SWG layer is characterized by one or more periodic dimensions characteristic of the diffractive structure. In the illustrated example, the periodic dimensions correspond to (a) the spacing of the lines, and (b) the line width in the x-direction. More specifically, sub-pattern 401 comprises lines of width w₁ periodically spaced with a period p₁; sub-pattern 402 comprises lines with width w₂ periodically spaced with a period p₂, and the sub-pattern 403 comprises lines with width w₃ periodically spaced with a period p₃. A grating sub-patterns form a sub-wavelength grating if a characteristic dimension thereof (e.g., periods p₁, p₂, or p₃) is smaller than the wavelength of the particular incident light for which it is designed to operate. For example, a characteristic dimension of a SWG (e.g., periods p₁, p₂, or p₃) can range from approximately 10 nm to approximately 300 nm or from approximately 20 nm to approximately 1 μm Generally, the characteristic dimensions of a SWG are chosen depending on the wavelength of the light for which a particular wavefront control device is designed to operate.

0^{th} order diffracted light from a sub-region acquires a phase φ determined by the line thickness t, and the duty cycle η, which is defined by:

$$η = \frac{w}{p} ,$$

where w is the line width and p is the period of the lines associated with the region.

Each of the grating sub-patterns 401-403 diffract incident light differently due to the different duty cycles and periods associated with each of the sub-patterns. SWG layer 400 may be configured to interface incident light in a specific manner by adjusting the period, line width, and line thickness of the lines.

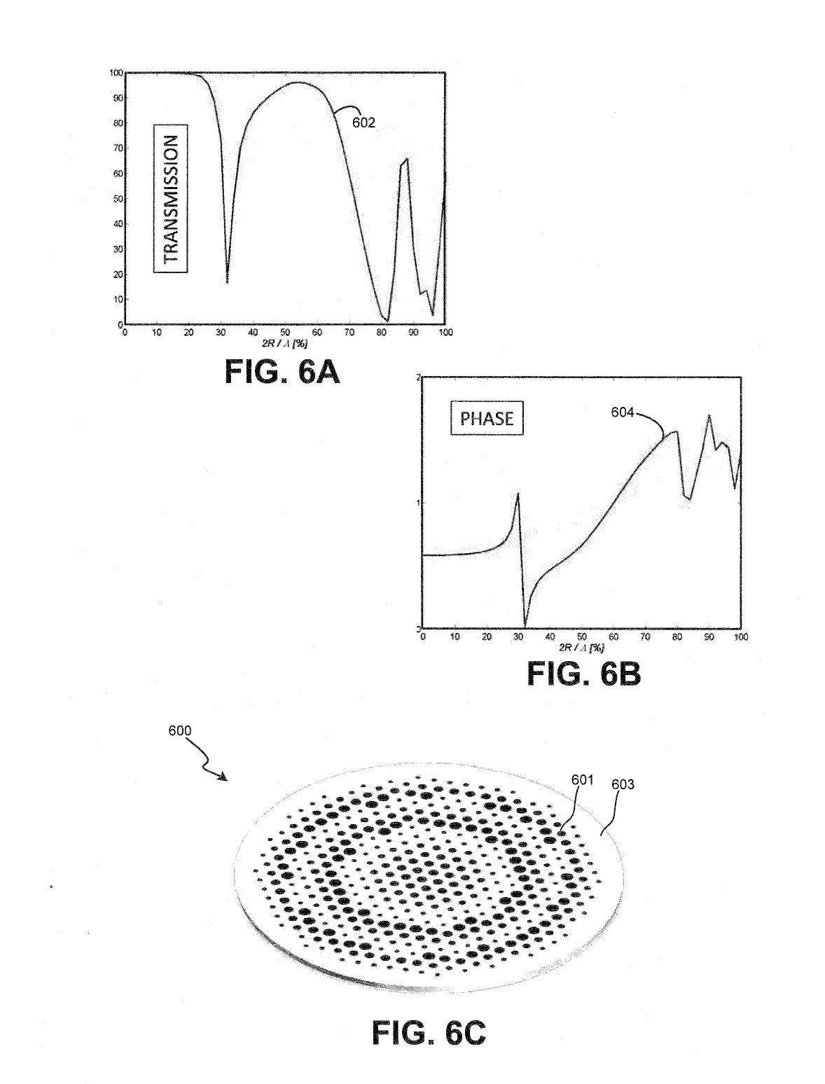

FIG. 5 shows a cross-sectional view of a SWG 500 according to an example. The Figure depicts portions of two separate grating sub-patterns 502 and 504 of SWG 500. The sub-patterns 502 and 504 can be located in different regions of SWG 500. The thickness t₁ of the lines of sub-pattern 502 are greater than the thickness t₂ of the lines of sub-pattern 504, and the duty cycle η₁ associated with the lines in sub-pattern 502 is greater than the duty cycle η₂ associated with the lines of sub-pattern 504.

FIGS. 4 and 5 illustrate SWGs based on a grating with a non-periodic sub-wavelength pattern. Such SWGs are characterized by a spatially varying refractive index, which facilitates implementing an arbitrary diffractive element. The basic principle is that light incident on a non-periodical SWG (e.g., SWG 500) may become trapped therein and oscillate for a period of time within portions of the grating. The light is ultimately transmitted through the SWG, but with the portion of light transmitted through a sub-region (e.g., sub-region 502) acquiring a larger phase shift than the portion of light transmitted through a sub-region with different characteristic dimensions (e.g., sub-region 504 with respect to sub-region 502).

As shown in the example of FIG. 5, incident wavefront 516 and 518 impinge on SWG 500 with approximately the same phase, but a wavefront 520 is transmitted through sub-pattern 502 with a relatively larger phase shift φ than the phase shift φ′ acquired by a wavefront 522 transmitted through sub-pattern 504.

In some examples, a SWG layer may be provided with reflecting layers disposed parallel to the SWG and adjacent to opposite sides thereof. Thereby, resonant cavities may be formed on both sides of the SWG. Light may then become trapped on these resonant cavities and become ultimately transmitted through the reflection layers with different phases in the beam similarly as shown in FIG. 5.

A SWG layer may be arranged with so-called polarized diffractive elements (hereinafter referred to as polarized SWG layer). In a polarized SWG layer, how light is reflected or transmitted therethrough depends on the specific polarization of incident light. More specifically, elements of the SWG may be arranged to be sensitive to polarization of incident light. Specifically, the thickness and pitch of the SWG may be chosen to be polarization sensitive as described in the international patent application with publication number WO2011136759, which is incorporated herein by reference to the extent in which this document are not inconsistent with the present disclosure and in particular those parts thereof describing SWG design.

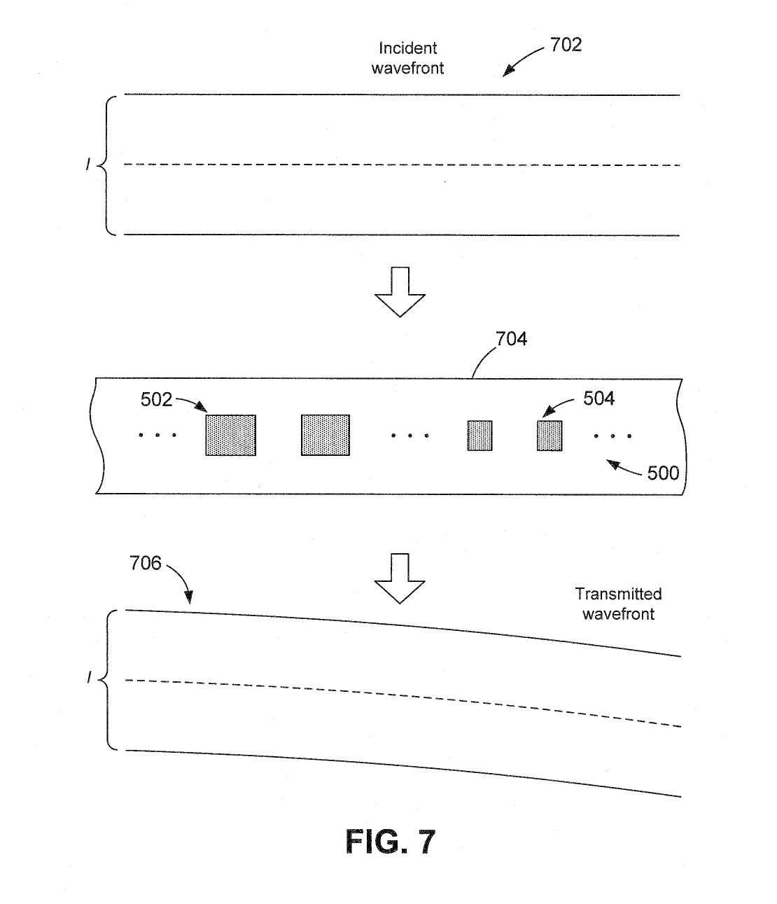

Alternatively, a SWG layer may be arranged with so-called unpolarized diffractive elements so that how light is reflected or transmitted therethrough does not substantially depend on the specific polarization of incident light. More specifically, elements of the SWG may be arranged to be insensitive to polarization of incident light. Such SWG layers are referred to as unpolarized SWG. An unpolarized SWG is designed by an appropriate selection of the pattern dimensions, using a transmission curve indicative of resonances for particular characteristics dimensions of the SWG, as illustrated in the following with respect to FIGS. 6A to 6C.

FIGS. 6A and 6B show plots of transmittance and phase shift as a function of duty cycle of a SWG layer 600 according to an example herein and illustrated in FIG. 6C. In FIG. 6A, curve 602 corresponds to transmission through SWG layer 600 with a pattern composed of a hexagonal array of silicon posts 601 in an oxide matrix 603 (see FIG. 6C) over a range of duty cycles. (In the graphs of FIGS. 6A, 6C, duty cycle is illustrated as a percent.) In FIG. 6B, curve 604 corresponds to phase of the transmission coefficient for SWG 600 over a range of duty cycles. In this example, duty cycles are defined as 2R/Λ, where R is a varying post radius, and Λ is a fixed lattice constant. For this specific example, Λ=475 nm; thickness of posts 601 is kept fixed at 130 nm; light wavelength was 650 nm.

As depicted by FIGS. 6A, 6B, SWG 600 features two resonances for duty cycle values of 32 and 80% respectively, where the reflection peaks and the transmission drops while undergoing a phase jump. Between these two resonances, the transmission is high and the transmitted phase varies smoothly by an amount slightly over 1.67π. Using data as shown by FIGS. 6A, and 6B an unpolarized transmissive SWG may be designed. More specifically, the dimensions of diffractive elements in the SWG layer may be chosen such that the transmission characteristics of sub-patterns of the grating are comprised between resonances in the transmission curves so that a SWG is insensitive to polarization of an incident wavefront. In the illustrated example, an unpolarized transmissive diffractive optic element for 650 nm wavelength may designed based on an array of 130 nm tall silicon posts with a fixed pitch of 475 nm and post diameters varying between 140 nm and 380 nm.

It is noted that the feature aspect ratio of a SWG layer with transmission characteristics of sub-patterns of the grating comprised between resonances in the transmission curves may be low as compared to SWG layers outside this regime as can be elucidated from the above example. The term “feature aspect ratio” refers to the ratio between the thickness of the pattern (e.g., thickness of posts or thicknesses t₁ or t₂ illustrated in FIG. 5) and the smallest dimension of the grating features (e.g. width of a ridge or post diameter).

Following the above procedures, an unpolarized SWG layer may be arranged to control a wavefront incident thereon or to perform other optical functions such as focusing, collimating, or expanding a wavefront incident thereon. The basic principle is to choose the dimensions of the dimensions of diffractive elements in the SWG such that the transmission characteristics of sub-patterns of the grating are comprised between resonances in the transmission curves. Moreover, using such design approach, a SWG layer may be arranged with a low aspect ratio such as an aspect ratio below 10:1 or, more specifically, an aspect ratio below 5:1 or, even more specifically, an aspect ratio below 1:1. Thereby, it is facilitated a straightforward mass production of SWG layers using micro-fabrication processes such as deep-UV or nano-imprint lithography. It will be understood that the example illustrated in FIGS. 6A to 6C, in which a hexagonal post pattern is illustrated, may be generalized for a vast variety of SWG geometries such as the SWG geometries illustrated with respect to FIG. 4, 8A, or 11A.

Some further examples of SWG layers with unpolarized diffractive elements are illustrated the article titled “A Silicon Lens for Integrated Free-Space Optics,” by Fattal et al. published in Integrated Photonics Research, Silicon and Nanophotonics, OSA Technical Digest (CD) (Optical Society of America, 2011), paper ITuD2, which is incorporated herein by reference to the extent in which this document are not inconsistent with the present disclosure and in particular those parts thereof describing SWG design.

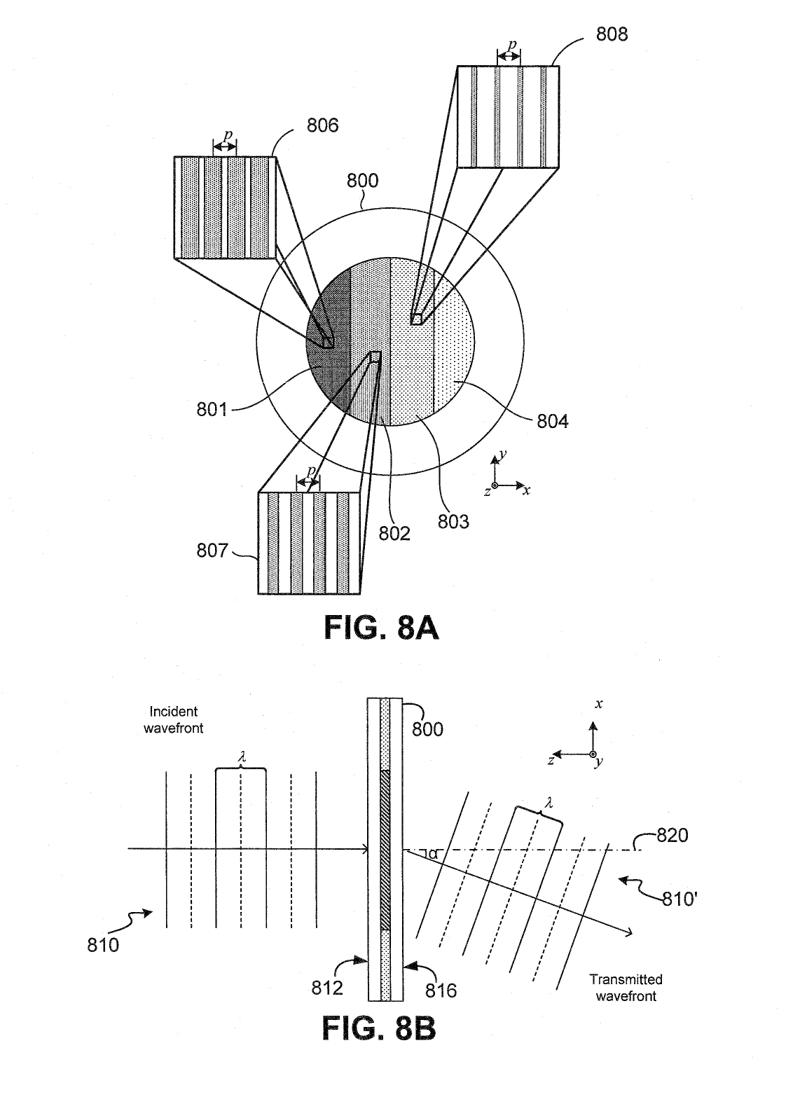

FIG. 7 shows a cross sectional view of a SWG layer 704 in operation illustrating how a transmitted wavefront may be changed according to an example. In the example, incident light with a substantially uniform wavefront 702 impinges on a SWG layer 704 producing transmitted light with a curved transmitted wavefront 706. Transmitted wavefront 706 results from portions of incident wavefront 702 interacting with sub-region 502 of SWG 500 with a relatively larger duty cycle η₁ and thickness t₁ than portions of incident wavefront 702 interacting with sub-region 504 of SWG 500 with a relatively smaller duty cycle η₇₂ and thickness t₂. The shape of the transmitted wavefront 706 is consistent with the larger phase acquired by light interacting with sub-region 502 relative to the smaller phase shift acquired by light interacting with the sub-region 504.

A SWG layer may be configured to provide arbitrary phase front shape modulation. Thereby, a SWG layer may be implemented in a wavefront control device to implement particular functions. These functions may include, deflecting a light beam, splitting a light beam into spectral components, filtering one or more spectral components in a light beam, focusing or defocusing an incident light beam, or collimating an incident light beam with a non-parallel wavefront. In the following some examples of SWG layers configured to implements these functions are illustrated.

In examples, a non-periodical SWG of a SWG layer may be configured so that the SWG layer operates like a prism, i.e. controlling incident light by producing transmitted light that is deflected relative to the incident light. Such a SWG may be realized by forming a pattern with a duty cycle progressively varying in one direction.

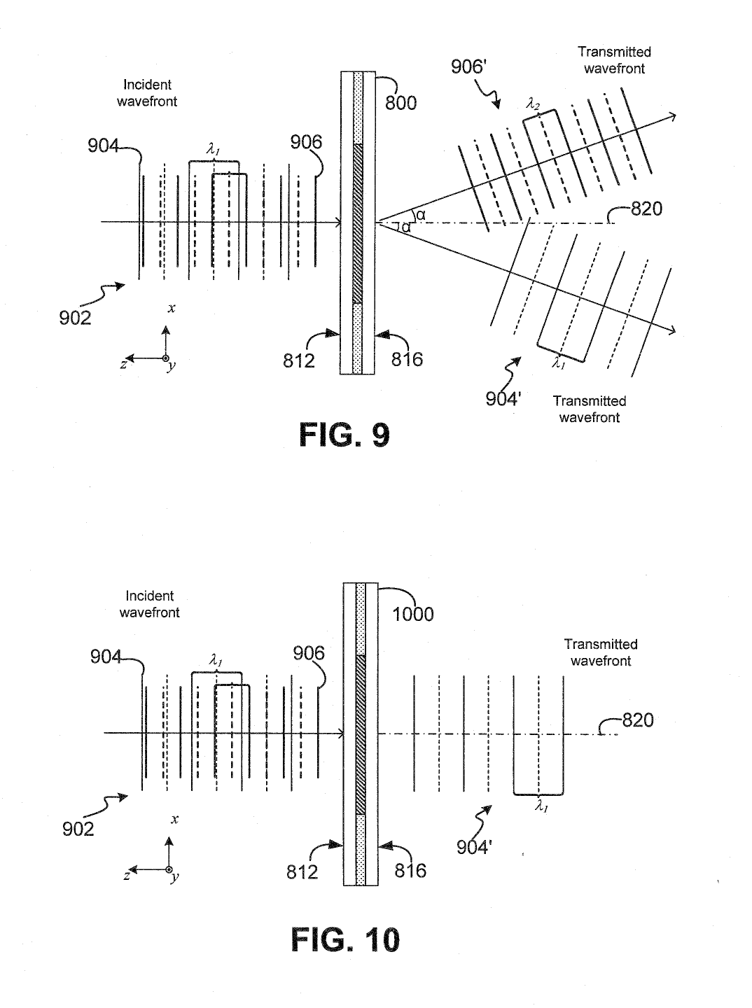

FIG. 8A shows a top plan view of a one-dimensional grating pattern of a SWG layer 800 configured to be operated as a prism for normal incident light of an appropriate wavelength; FIG. 8B shows a cross-sectional view of SWG layer 800 in operation. The non-periodic SWG of SWG layer 800 includes regions 801-804, with each region formed from lines extending in the y-direction, having the same period, but with the duty cycle progressively decreasing from region 801 to region 804. Enlargements 806-808 reveal that line period spacing p is the same throughout, but the lines of region 801 have a relatively larger duty cycle than the lines of region 802, which have a larger duty cycle than the lines of region 803. The duty cycles for regions 801-804 are selected such that the resulting phase change in transmitted light is largest for region 801 and decreases from region 801 to region 804.

As depicted in FIG. 8B, the phase change causes a parallel wavefront 810 (corresponding to a beam of light with wavelength λ directed normal to an input surface 812 of SWG layer 800) to be transmitted through an output surface 816 of SWG layer 800 as a transmitted wavefront 810′ travelling with an angle α away from a surface normal 820.

In examples, a non-periodical SWG of a SWG layer configured to operate like prism may act as a beam splitter when light including multiple spectral components impinges thereon.

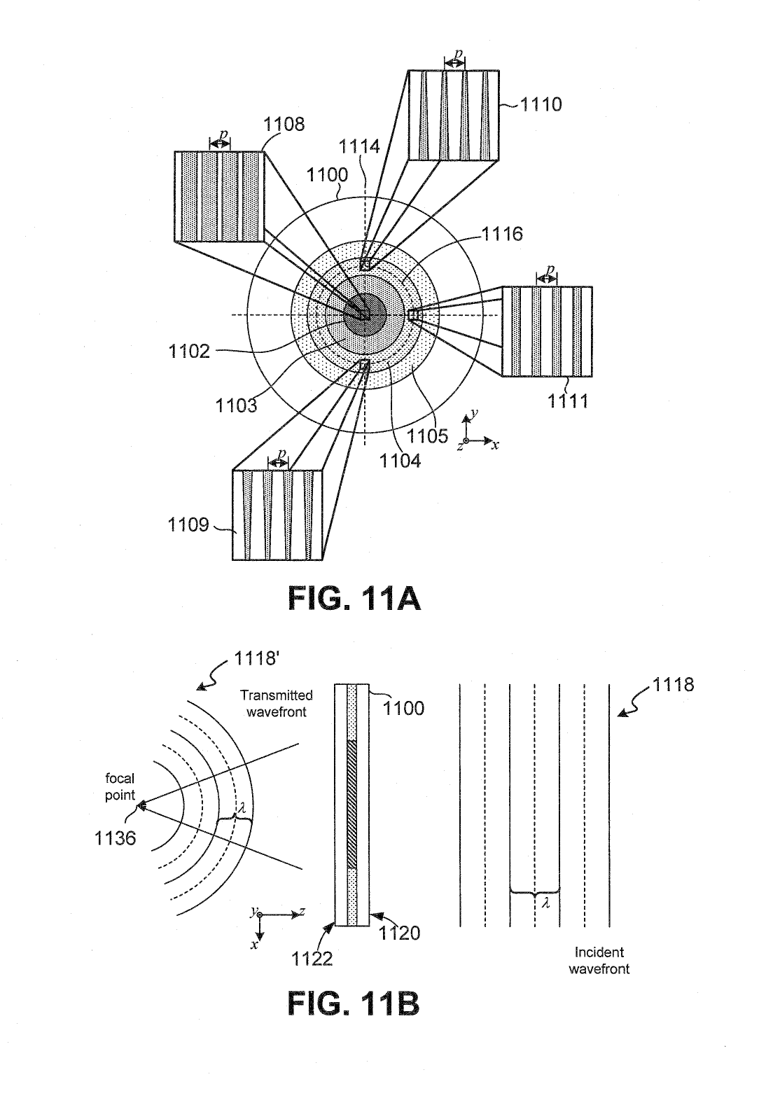

FIG. 9 shows a cross-sectional view of SWG layer 800 in operation for splitting a wavefront 902 composed of multiple spectral components. In the illustrated example, wavefront 902 includes (i) a first spectral component 904 corresponding to light of wavelength λ₁ (illustrated with thin lines), and (ii) a second spectral component 906 corresponding to light of wavelength λ₂ (illustrated with thick lines). SWG layer 800 induces different phase changes to the different spectral component of the incident wavefront since interaction of light with the grating pattern is wavelength dependent.

The diffractive features may be designed to control a multiple-component wavefront as required for a particular application thereof In the example depicted in FIG. 9, SWG layer 800 is designed to control wavefront 902 such that the spectral components thereof are deflected at symmetrical angles a. More specifically, the phase change induced by SWG layer 800 causes (i) the spectral component 904 of wavefront 902, corresponding to a beam of light with wavelength λ₁, to be transmitted through output surface 816 with an angle α away from surface normal 820, and (ii) spectral component 906 of wavefront 902, corresponding to a beam of light with wavelength λ₂, to be transmitted through output surface 816 with an angle −α away from surface normal 820. It will be understood that a SWG layer may be designed to split a multiple-component wavefront in any manner as required for implementing a specific function in a wavefront control device.

In examples, a non-periodical SWG of a SWG layer may be configured to control an incident wavefront by operating like a filter element when light including multiple spectral components impinges thereon.

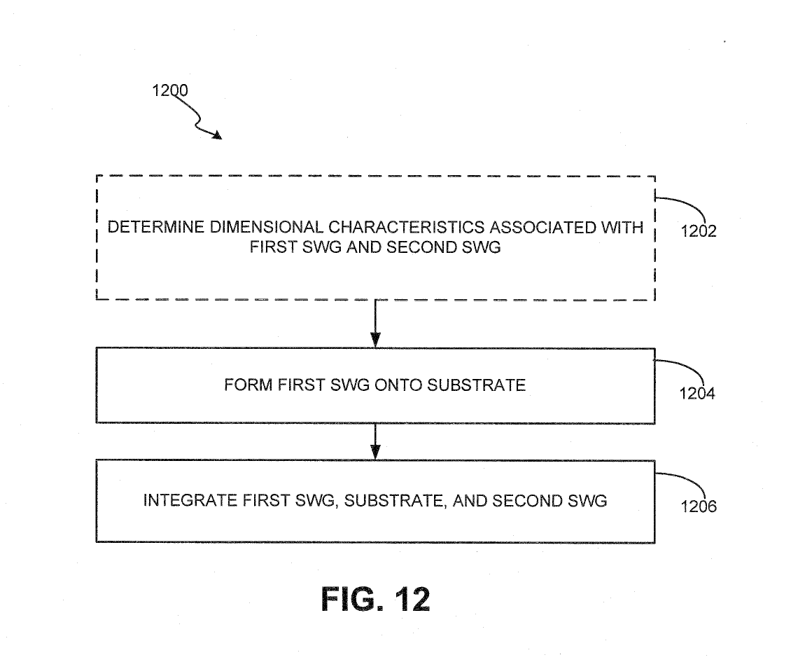

FIG. 10 shows a cross-sectional view of SWG layer 1000 in operation for filtering a particular spectral component of a wavefront 902 composed of multiple spectral components. In the illustrated example, wavefront 902 includes (i) a first spectral component 904 corresponding to light of wavelength λ₁ (illustrated with thin lines), and (ii) a second spectral component 906 corresponding to light of wavelength λ₂ (illustrated with thick lines). SWG layer 1000 induces different phase changes to the different spectral component of the incident wavefront since interaction of light with the grating pattern is wavelength dependent. Moreover, SWG layer 1000 is specifically designed to filter second spectral component 906 by blocking light of wavelength λ₂.

The diffractive features may be chosen to selectively filter a multiple-component wavefront as required for a particular application thereof In the example depicted in FIG. 10, SWG layer 1000 is designed to control wavefront 902 such that spectral components with wavelength λ₂, or close thereto, are blocked and spectral components with other wavelengths are transmitted therethrough. More specifically, the phase change induced by SWG layer 1000 causes (i) the spectral component 904 of wavefront 902, corresponding to a beam of light with wavelength λ₁, to be transmitted through output surface 816 without deflection, and (ii) the spectral component 906 of wavefront 902, corresponding to a beam of light with wavelength λ₂, to be absorbed at the grating. It will be understood that a SWG layer may be designed to filter a multiple-component wavefront in any manner as required for implementing a specific function in a wavefront control device. For example, the SWG layer may filter some spectral components while splitting other spectral components.

In examples, a non-periodical SWG of a SWG layer may be configured such that the SWG layer operates like a lens, which might be configured for, for example, focusing, collimating, or expanding an incident light beam. Such a SWG layer operating as a lens may be realized by forming a SWG pattern with a duty cycle symmetrically varying with respect to an axis of symmetry, the axis of symmetry defining an optical axis of the SWG layer.

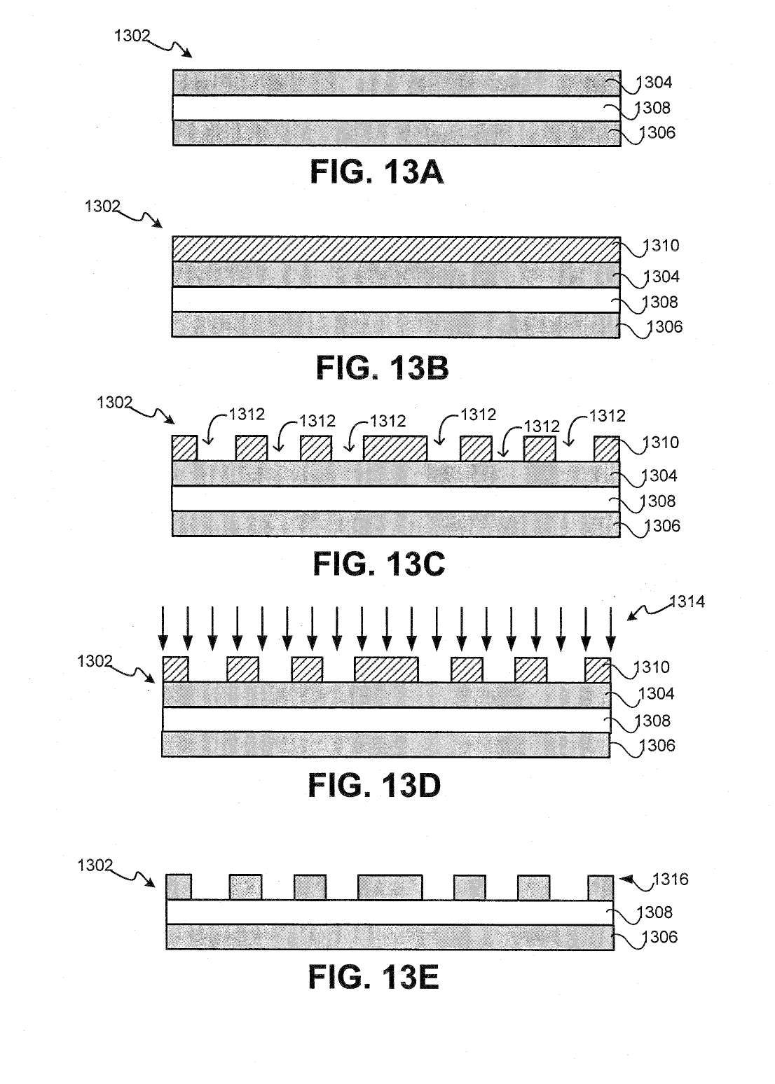

FIGS. 11A and 11B illustrate SWG layers arranged to be operated as a lens by depicting a particular SWG layer 1100 that can be operated as a convex lens for focusing incident light. FIG. 11A shows a top plan view of a one-dimensional grating pattern of a SWG layer 1100 configured to be operated as a convex lens for focusing incident light into a focal point 1136 by appropriately tapering the lines of the grating away from the center of SWG-layer 1100; FIG. 11B shows a cross-sectional view of SWG layer 1100 in operation.

SWG layer 1100 includes a non-periodical SWG with a grating pattern represented by annular shaded regions 1102-1105. Each shaded annular region represents a different grating sub-pattern of lines. Enlargements 1108-1111 show that the SWG includes lines tapered in the y-direction with a constant line period spacing p in the x-direction. More specifically, enlargements 1108-1110 are enlargements of the same lines running parallel to dashed-line 1114 in the y-direction. Enlargements 1108-1110 reveal that the line period spacing p remains constant but the width of the lines narrow or taper away from the center of the SWG in the y-direction. Each annular region has the same duty cycle and period. For example, enlargements 1108-1111 reveal portions of annular region 1104 comprising portions of different lines that have substantially the same duty cycle. As a result, each portion of an annular region produces the same approximate phase shift in the light transmitted through SWG layer 1100. For example, dashed circle 1116 represents a single phase shift contour in which light transmitted through the SWG layer anywhere along the circle 1116 acquires substantially the same phase φ.

As depicted in FIG. 11B, the phase change causes a parallel wavefront 1118 corresponding to a beam of light with wavelength λ directed normal to an input surface 1112 of SWG layer 1100 to be transmitted through an output surface 1122 of SWG layer 1122 as an output wavefront 1118′ converging towards focal point 1136.

A SWG layer is not limited to one-dimensional gratings as illustrated with respect to FIG. 4, 5, 8A, or 11A. The SWG layer can be configured with a two-dimensional non-periodical SWG so that the SWG layer can be operated to implement a specific wavefront control function or other optical functions such as focusing, expanding, or collimating an incident beam. In examples, a non-periodical SWG is composed of posts rather lines, the posts being separated by grooves. The duty cycle and period can be varied in the x- and y-directions by varying the post size. In other examples, a non-periodical SWG layer is composed of holes separated by solid portions. The duty cycle and period can be varied in the x- and y-directions by varying the hole size. Such post or holes may be arranged according to a variety of shapes such as a circular or rectangular shape.

An SWG layer can be arranged to implement a particular optical function by appropriately designing a phase change induced to an incident wavefront. There is a number of ways for designing the induced phase change. In an example, for configuring the SWG layer, a transmission profile thereof may be determined using an appropriate computing tool, such as the application “MIT Electromagnetic Equation Propagation” (“MEEP”) simulation package to model electromagnetic systems, or COMSOL Multiphysics® which is a finite element analysis and solver software package that can be used to simulate various physics and engineering applications. A determined transmission profile may be used to uniformly adjust geometric parameters of the entire SWG layer in order to produce a particular change in the transmitted wavefront.

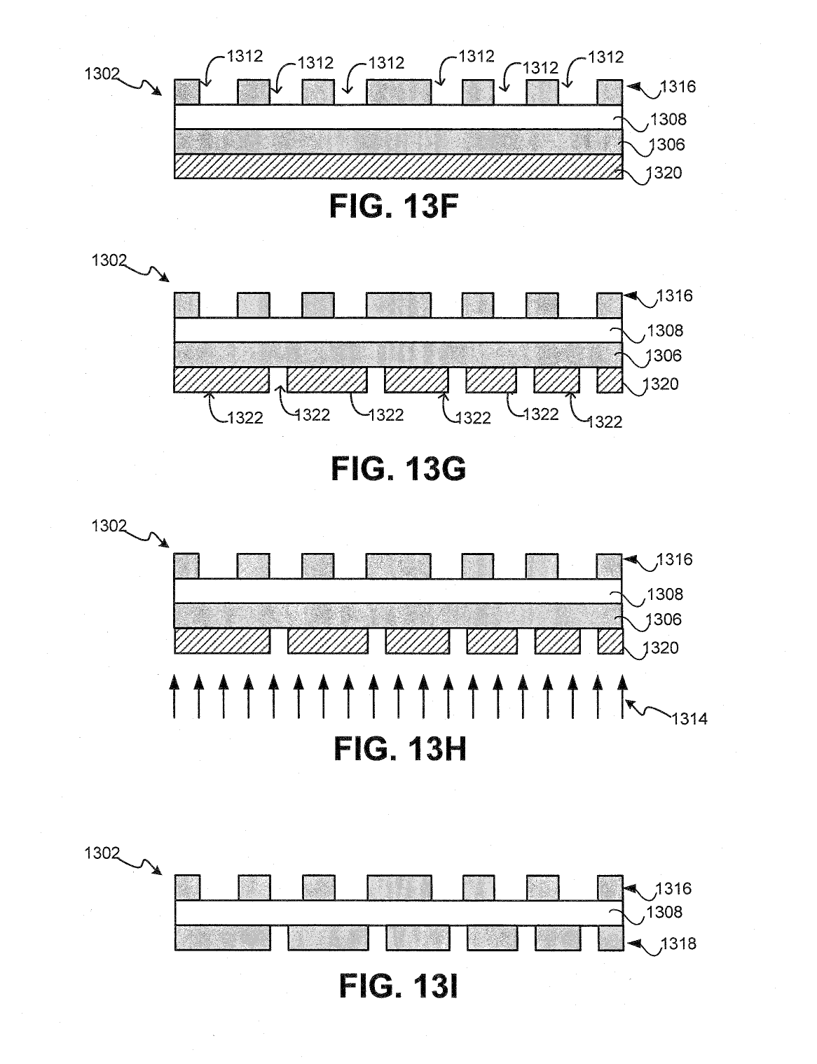

FABRICATING WAVEFRONT CONTROL DEVICES: FIG. 12 illustrates examples of a method 1200 for manufacturing a wavefront control device. At 1202, dimensional characteristics associated with a first SWG and a second SWG are determined to set the shape of electromagnetic wavefront transmitted therethrough. More specifically, a SWG layer can be arranged to implement a particular optical function in the wavefront control device by appropriately designing an appropriate phase change induced to an incident wavefront, as set forth in the Section above. Alternatively, the dimensions of the SWG layers to be formed may be pre-determined before performing method 1200, which can be then performed according to the pre-determined dimensions.

At 1204 a first SWG layer is formed on a substrate. Further, at 1206 the first SWG layer, the substrate, and a second SWG layer are integrated. For example, these components may be integrated so as to form a single and solid body as further detailed below. Method 1200 may also include integrating additional SWG layers in the device. The SWG layers may be integrated one upon another so as to form a stack. At least one of the SWG layers is arranged to control a wavefront incident on the device. Other SWG layers may be arranged to perform other optical functions such as focusing, collimating, or expanding wavefronts incident thereon.

The SWG layers of a wavefront control device as described herein may be manufactured using micro-fabrication such as lithography, imprint processes, layer deposition, or a combination thereof. More specifically, SWG layers may be designed with a feature aspect ratio below 10:1 or, more specifically, an aspect ratio below 5:1 or, more specifically an aspect ratio below 1:1 following the procedure set forth above with respect to FIGS. 6A-6C. SWG layers designed this way facilitate a convenient production thereof since higher feature aspect ratios render it difficult to use micro-fabrication techniques such as deep-UV or nano-imprint lithography.

There is a number of ways of integrating the SWG layers in a wavefront control device. For example, a first SWG layer may be formed on a first side of the substrate and a second SWG layer may be formed on a second side of the substrate opposite to the first side, as illustrated with respect to FIGS. 13A-13I. In other examples, the first layer is formed by depositing alternating layers of different materials on the substrate and the second SWG layer is formed over the first SWG by depositing alternating layers of different materials over the first SWG, as illustrated with respect to FIGS. 14A-14K. In still other examples, a first SWG layer and the first substrate form part of a first integrated structure; a second SWG layer is formed on a second substrate, the second SWG layer and the second substrate form part of a second integrated structure; integration may be then performed by bonding the first integrated structure and the second integrated structure to each other, as illustrated with respect to FIGS. 15A-15B.

Referring to FIGS. 13A to 13I, these Figures illustrate an example of a process that can be utilized to manufacture a wavelength control device as described herein. Specifically, the depicted process facilitates forming a wavefront control device including an integrated structure 1302 in which (a) a first SWG layer 1316 is formed on one side of a substrate, and (b) a second SWG layer 1318 is formed on the opposite side of the substrate.

FIG. 13A illustrates an example diagram of a structure 1302 including grating material films 1304, 1306 formed on opposite sides of a substrate 1308. Grating material film 1304 may be dielectric films that can be deposited onto substrate 1308, can be oxidized from a layer of substrate material (e.g., through thermal oxidation), or can be formed via sputtering, chemical vapor deposition, or other suitable technique. Grating material films 1304, 1306 can be formed from any one of a variety of materials, such as silicon (“Si”), gallium arsenide (“GaAs”), indium phosphide (“InP”), silicon carbide (“SiC”), or a combination thereof Substrate 1308 can be formed from a variety of transparent materials, such as silica or another transparent medium such as an appropriate polymer. Grating material films 1304, 1306 can be formed on substrate 1308 to have a thickness optimized along with other grating parameters to achieve implementing an optical function by way of a SWG layer as described above.

FIG. 13B illustrates an example diagram of structure 1302 including an additional mask film (e.g., a photoresist) 1310 applied over grating material film 1304. Photoresist film 1310 may have a thickness of about 500 Å to about 5000 Å. However, it will be understood that the thickness thereof may be of any dimension suitable for fabricating a wavelength control device as described herein. For instance, the thickness of the photoresist film 1310 can vary in correspondence with the wavelength of radiation used for patterning this film. Photoresist film 1310 may be formed over grating material film 1304 via spin-coating or spin casting deposition techniques.

FIG. 13C illustrates an example of structure 1302 with photoresist film 1310 having been patterned to form a plurality of gaps 1312. Each of gaps 1312 in the photoresist layer can be dimensioned to have dimensions that are predetermined according to desired optical properties of the SWG layer being constructed. The gaps 1312 thus provide a diffractive pattern (e.g. a lined pattern or any of the patterns illustrated above) in the patterned photoresist film 1310 at predetermined locations. Patterned photoresist film 1312 can thus serve as an etch mask film for processing or etching the underlying grating material layer 1304 to include a corresponding diffraction pattern.

FIG. 13D illustrates an example diagram of structure 1302 undergoing etching, as indicated by arrows 1314. The etch can be performed by plasma etching (e.g., an anisotropic deep reactive ion etching (DRIE) technique). However, any suitable etch technique may be used to etch the grating material film 1304. For example, grating material film 1304 can be anisotropically etched with one or more plasma gases, such as carbon tetrafluoride (CF₄) containing fluorine ions, in a commercially available etcher, such as a parallel plate DRIE apparatus or, alternatively, an electron cyclotron resonance (ECR) plasma reactor to replicate the mask pattern of the patterned photoresist film.

FIG. 13E illustrates an example diagram of structure 1302 after the etching step is complete resulting in the completion of a first SWG layer 1316. A stripping step (e.g., ashing in an O₂ plasma) may be performed to remove remaining portions of patterned photoresist film 1310. Therefore, the SWG layers include gaps that have been etched via the etch process of the example of FIG. 13D in the dielectric material film 1310, thus leaving a grating pattern that may have any of the configurations illustrated above.

Substantially, the same process described above with respect to grating material layer 1304 (illustrated in FIGS. 13B to 13E) is performed on grating material layer 1306 so as to form a second SWG layer 1318 at the side of substrate 1308 opposite to the side where first SWG layer 1316 is formed. As illustrated in FIG. 13F, an additional mask film (e.g., a photoresist) 1320 is applied over grating material film 1306. As illustrated in FIG. 13G, photoresist film 1320 is patterned so as to form a plurality of gaps 1322. As illustrated in FIG. 13H, structure 1302 may undergo a further etching, as indicated by arrows 1324, to effect patterning of grating material 1306. FIG. 13I illustrates structure 1302 after the etching is completed resulting in a second SWG layer 1316.

The above process results in a wavefront control device that includes a transparent substrate 1308 acting as a spacer between first SWG layer 1316 and a second SGW 1318. Such process is a convenient approach for manufacturing a portion of a wavefront control device that can be implemented for mass-production without sacrificing high precision positioning between the SWG layers. As depicted in the Figures, SWG layer 1318 is arranged to control an incident light wavefront by providing it with a non-periodic SWG with a characteristic dimension, in this example a post width, progressively increasing towards the left direction in FIG. 13I.

Referring to FIGS. 14A to 14K, these Figures illustrate another example of a process that can be utilized to manufacture a wavelength control device as described herein. Specifically, the depicted process facilitates forming a wavefront control device including an integrated structure 1402 in which a first SWG layer 1418 and a second SWG layer 1434 are layered over a substrate 1406.

FIG. 14A illustrates an example diagram of a structure 1402 including grating material film 1404 formed on a substrate 1406. Grating material film 1404 and substrate 1406 may be similar to, respectively, any of grating material films 1304, 1306 and substrate 1308 referred to above with respect to FIG. 13A.

FIG. 14B illustrates an example diagram of structure 1402 including an additional mask film (e.g., a photoresist) 1408 applied over grating material film 1304. Photoresist film 1408 may be formed similarly as photoresist film 1310 described above with respect to FIG. 13B.

FIG. 14C illustrates an example of structure 1402 with photoresist film 1408 having been patterned to form a plurality of gaps 1410, which are formed similarly as gaps 1312 described above with respect to FIG. 13C.

FIG. 14D illustrates an example diagram of structure 1402 undergoing etching, as indicated by arrows 1412, similarly as described with respect structure 1302 in FIG. 13D.

FIG. 14E illustrates an example diagram of structure 1402 after the etching step is complete resulting in the completion of a SWG 1414.

FIG. 14F illustrates an example diagram of structure 1402 after undergoing a deposition step in which a transparent film 1416 is deposited on substrate 1406 and SWG 1414. Transparent film 1416 may be comprised of a suitable transparent material such as a silicon oxide. SWG 1414 and transparent film 1416 forms a first SWG layer 1418.

FIG. 14G illustrates an example diagram of a structure 1402 including (a) an additional grating material film 1420 formed on first SWG layer 1418, and (b) an additional mask film (e.g., a photoresist) 1422 applied over additional grating material film 1420. Additional grating material film 1420 and photoresist film 1422 are, respectively, formed similarly to grating material film 1404 and photoresist film 1408.

Substantially, the same process described above with respect to grating material film 1404 and photoresist film 1408 (illustrated in FIGS. 14B to 14E) is performed on additional grating material film 1420 and photoresist film 1422 so as to form a second SWG layer 1424 stacked over first SWG layer 1418. As illustrated in FIG. 14H, photoresist film 1422 is patterned to form a plurality of gaps 1426. As illustrated in FIG. 14I, structure 1402 may undergo a further etching, as indicated by arrows 1428, to effect patterning of additional grating material 1420. FIG. 14J illustrates structure 1402 after the etching is completed resulting in a SWG 1430 formed on first SWG layer 1418. As illustrated in FIG. 14J, a transparent layer 1432, similar to transparent layer 1416, may be deposited on first SWG layer 1418 and grating 1430 so that grating 1430 and transparent layer 1432 forms a second SWG layer 1434.

The above process facilitates manufacturing a wavefront control device that includes substrate 1406 over which SWG layers are stacked by deposition. As depicted in the Figures, SWG layer 1434 is arranged to control an incident light wavefront by providing it with a non-periodic SWG with a characteristic dimension, in this example a post width, progressively increasing towards the left direction in FIG. 14K.

Substrate 1406 may be transparent in case that the wavefront control device can be operated as a device for transmitting a controlled beam of light. Alternatively, substrate 1406 or a neighboring layer(such as SWG layer 1418) may be configured to reflect light so that the wavefront control device can be operated as a device for reflecting a controlled beam of light. Transparent film 1416 acts as a spacer between the SWG 1414 and SWG 1416. Further transparent films may be interposed between adjacent SWGs. Moreover, further SWG layers may be stacked over substrate 1406 so as to implement further optical functions of the wavefront control device. Such process is a convenient approach for manufacturing a portion of a wavefront control device that can be implemented for mass-production without sacrificing high precision positioning between the SWG layers. Moreover, such a wavefront control device can be conveniently be configured to be operated for controlling an incident wavefront by reflection thereof as set forth above.

Referring to FIGS. 15A and 15B, these Figures illustrate a further example of a process that can be utilized to manufacture a wavelength control device as described herein. Specifically, the depicted process facilitates forming a wavefront control device by bonding two integrated structures 1502 and 1504. The integrated structures include, respectively, a substrate 1506, 1508 over which a SWG layer 1510, 1512 is formed.

FIG. 15A illustrates integrated structures 1502 and 1504. First integrated structure 1502 includes substrate 1506 over which SWG layer 1510 is formed; second integrated structure 1504 includes substrate 1508 over which SWG layer 1512 is formed. Substrates 1506, 1508 are transparent substrate similar to substrate 1308 described above with respect to FIG. 13A. SWG layers 1510, 1512 may be formed following a process as illustrated above with respect to FIGS. 13A-14K. Each integrated structure may include further SWG layers formed either over the same side of the substrate or over different sides of the substrate. As depicted in the Figures, SWG layer 1512 is arranged to control an incident light wavefront by providing a non-periodic SWG with a characteristic dimension, in this example a post width, progressively increasing towards the left direction in FIG. 15B.

FIG. 15B illustrates structure 1514 formed by bonding integrated structures 1502 and 1504 as schematically depicted by arrow 1516 in FIG. 15A. This process facilitates manufacturing a wavefront control device that includes a stack of SWG layers where transparent substrates 1506 and 1508 are interposed between SWG layer 1510 and 1512. Bonding may include any of the following methods: direct bonding, plasma activated bonding, anodic bonding, eutectic bonding, glass frit bonding, adhesive bonding, thermo-compression bonding, or reactive bonding.

The above manufacturing methods may be combined with each other for realizing a particular wavefront control device. For example, a SWG layer stack may be formed by deposition on a first substrate and may be bonded on another substrate; subsequently, further SWG layers may be stacked on top of the latter substrate.

The examples described above provide wavefront control devices which facilitate integrating optical functionalities. Further, wavefront control devices described herein facilitate a convenient manufacturing using micro-fabrication methods without sacrificing optical performance. In the foregoing description, numerous details are set forth to provide an understanding of the examples disclosed herein. However, it will be understood that the examples may be practiced without these details. While a limited number of examples have been disclosed, numerous modifications and variations therefrom are contemplated. Specifically, it will be understood that the number and arrangement of SWG layers illustrated above are chosen to describe some particular examples. Wavefront control devices are contemplated that include any number and arrangement of SWG layers suitable to implement a particular control of an incident wavefront.

It is intended that the appended claims cover modifications and variations of the illustrated examples. Claims reciting “a” or “an” with respect to a particular element contemplate incorporation of one or more such elements, neither requiring nor excluding two or more such elements.

What is claimed is:

1. A wavefront control device to control a light wavefront, the device comprising:
a plurality of stacked sub-wavelength grating (SWG) layers including a SWG layer arranged to control a light wavefront.

2. The device of claim 1, wherein at least one of the plurality of stacked SWG layers is formed on a substrate.

3. The device of claim 1, wherein the aspect ratio of features of the at least one SWG layer formed on the substrate is below 10:1.

4. A wavefront control device to control a light wavefront, the device comprising:
a first SWG layer and a second SWG layer, at least one of the SWG layers being arranged to control a light wavefront; and
a spacer interposed between the first and the second SWG layers, the spacer defining the relative position between the first SWG layer and the second SWG layer.

5. The device of claim 4, wherein the spacer includes a first substrate, the first SWG layer being formed on a first side of the first substrate.

6. The device of claim 5, wherein:
the second SWG layer is formed on a second side of the first substrate opposite to the first side of the first substrate; and
the substrate is transparent.

7. The device of claim 5 further comprising
a second substrate onto which the second SWG layer is formed,
a first integrally formed structure including the first substrate and the first SWG layer; and
a second integrally formed structure including the second substrate and the second SWG layer, wherein
the first integrated structure and the second integrated structure are bonded to each other.

8. The device of claim 5, wherein the first SWG layer is formed in a first deposition layer deposited onto said first substrate.

9. The device of claim 5, wherein
the second SWG layer is formed in a second deposition layer deposited onto the first deposition layer, and
the first substrate is a reflector and the first SWG and the second SWG are disposed at one side of the first substrate.

10. A method of manufacturing a wavefront control device, the method comprising:
forming a first SWG layer on a first substrate; and
integrating the first SWG layer, the first substrate, and a second SWG layer, one of the first or the second SWG layer being arranged to control a light wavefront incident in the wavefront control device.

11. The method of claim 10, wherein forming the first SWG layer over the substrate includes micro-fabricating the first SWG layer onto the first substrate.

12. The method of claim 10, wherein
forming the first SWG layer includes forming the first SWG layer on a first side of the first substrate, and
integrating includes forming the second SWG on a second side of the first substrate opposite to the first side.

13. The method of claim 10, wherein forming the first SWG over the first substrate includes alternately depositing films of different materials.

14. The method of claim 10, wherein integrating includes forming the second SWG over the first SWG by alternately depositing films of different materials over the first SWG.

15. The method of claim 10, wherein
the first SWG layer and the first substrate form part of a first integrated structure;
the second SWG is formed on a second substrate, the second SWG layer and the second substrate forming part of a second integrated structure;
the method further includes bonding the first integrated structure and the second integrated structure to each other.
